(19) United States
(12) Patent Application Publication
(10) Pub. No.: US 2009/0017702 A1
(43) Pub. Date: Jan. 15, 2009

(54) CLAMPING PART WITH CONDUCTING BODY IN THE FORM OF AN OVERTURNED L FOR CONNECTING ELECTRIC CABLES

(75) Inventor: Giordano Pizzi, Milano (IT)

Correspondence Address: MINTZ, LEVIN, COHN, FERRIS, GLOVSKY AND POPEO, P.C;ATTN: PATENT INTAKE CUSTOMER NO. 30623, ONE FINANCIAL CENTER, BOSTON, MA, 02111, US

(73) Assignee: MORSETTITALIA S.P.A., Milano (IT)

(21) Appl. No.: 12/171,384

(22) Filed: Jul. 11, 2008

(30) Foreign Application Priority Data
Jul. 12, 2007 (IT) MI2007A 001390

(51) Int. Cl. H01R 4/38

(52) U.S. Cl. 439/812

(57) ABSTRACT

A wire clamp for connecting electric wires includes a conducting body having a horizontal portion and a vertical portion in the form of an overturned L. The vertical portion includes an opening adapted to receive the bare end of a wire for clamping and the horizontal portion includes an engagement element adapted to engage an actuating element, such as a screw, for actuating the conducting body in the vertical direction to clamp the wire against a horizontal element. The horizontal portion can include a free end that is folded downward, extending in a vertical direction. The folded free end can interfere with the actuating element causing the actuating element to lock.

### BACKGROUND

1. Technical Field of the Invention

The present invention relates to a clamping part for connecting electric wires, comprising a conducting body substantially in the form of an overturned L.

2. Description of the Prior Art

It is known in the technical sector relating to electrical connection devices such as terminal strips, connection boxes and the like to use terminals able to be mounted on associated supports and to provide frontal access to the means—normally of the screw type—for retaining the electrical connection wires which form the electric circuit.

It is also known that said means for retaining the end of the electric wire are normally formed using so-called sliders which are movable in a direction perpendicular to that in which the wire is inserted, upon operation of a screw which recalls the slider which grips the wire between the slider and a counter-plate extending parallel to the wire and able to ensure electrical continuity of the circuit inside the device.

Known alternatives to these sliders moved by a screw include wire clamping parts formed by a resilient plate which is deformed by means of compression in order to allow opening of a slit and insertion of the wire into its seat; once insertion has been completed, the plate is released and, returning resiliently into the rest position, ensures clamping of the wire against the counter-plate and electrical connection.

### SUMMARY

Although fulfilling their function, these known clamping means nevertheless have drawbacks which in the case of the screw-type slider are essentially due to the following: the presence of the screw itself which tends to come loose with time, not guaranteeing the necessary clamping of the wire and the fact that the latter is clamped between two flat surfaces whose complex forms are difficult to produce, resulting in an irregular flatness which does not ensure full electric contact between the wire and terminal.

In the case of the spring, on the other hand, the drawback arises from the resilient force which must be imparted to the plate in order to ensure adequate clamping of the wire, said resilient force, which increases with an increase in the electric loads, making the wire insertion operation difficult.

The technical problem which is posed, therefore, is to provide a clamping part for electric wires, in particular for use inside connection devices such as terminal strips, connection boxes, distribution switchboards for wired circuits and the like, which has compact overall dimensions, but which at the same time is able to support a high electric load and combines the ease of a screw-type clamping system with the advantages of irreversible clamping achieved with a resilient plate.

In connection with this problem it is also required that this clamping part should be easy and inexpensive to produce, should be able to be used equally well with any of the various types of electrical connection devices and should be able to be easily operated by any user using normal standard tools.

These results are achieved according to the present invention by a clamping part for connecting electric wires, comprising a conducting body where said conducting body has the form of an overturned L.

### BRIEF DESCRIPTION OF THE FIGURES

Further details may be obtained from the following description of a non-limiting example of embodiment of the subject of the present invention provided with reference to the accompanying drawings in which:

FIG. 1 shows a perspective view of a first embodiment of the clamping part for electric wires according to the present invention;

FIG. 2 shows a schematic cross-sectional view, along a vertical longitudinal plane, of the clamping part according to FIG. 1;

FIG. 3 shows a schematic cross-sectional view, along a vertical plane, of a first mode of application of the clamping part according to the present invention;

FIG. 4 shows a schematic cross-sectional view, along a vertical plane, of a mode of application of the clamping part according to the present invention;

FIG. 5 shows a schematic cross-sectional view, along a vertical longitudinal plane, of a terminal block for switchboards with a clamping part according to the present invention;

FIG. 6 shows a cross-sectional view, similar to that of FIG. 5, of a further application of the clamping part according to the present invention;

FIG. 7 shows a perspective view of a second embodiment of the clamping part for electric wires according to the present invention; and

FIG. 8 shows a schematic cross-sectional view, along a vertical longitudinal plane, of the clamping part according to FIG. 7.

### DETAILED DESCRIPTION OF PREFERRED EMBODIMENTS

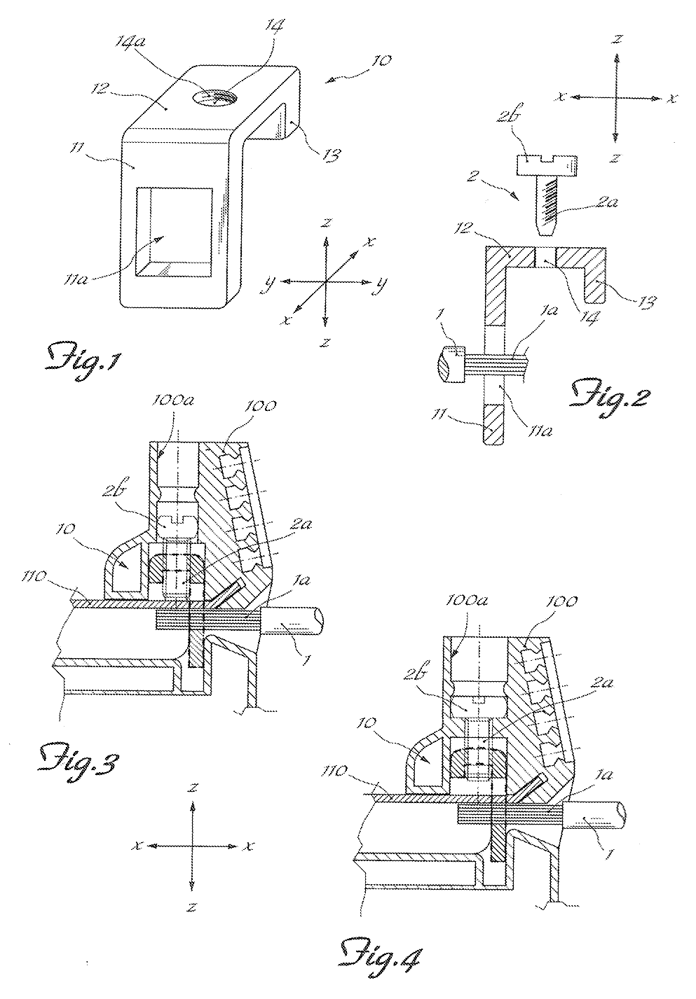

As shown in FIG. 1 and assuming for the sole sake of convenience of the description and without a limiting meaning a set of three reference axes, in a longitudinal direction X-X, transverse direction Y-Y and vertical direction Z-Z, respectively, the clamping part 10 according to the present invention comprises a conducting body substantially in the form of an overturned L, with a vertical face 11 having a length greater than the longitudinal horizontal face 12; the latter has a free end 13 folded downwards in a substantially vertical direction Z-Z.

The vertical face 11 has an opening 11a able to allow entry, in the longitudinal direction X-X, of the end 1a of the wire 1 (FIG. 2), while a hole 14 with a female thread 14a suitable for engagement with a corresponding thread 2a of an actuating screw 2 is formed in the horizontal face 12.

As shown in FIG. 3, it is envisaged that the clamping part 10 may be inserted inside a switchboard terminal block 100, inside which it operates with a screw 2 which acts with its shank 2a on the counter-plate 110 extending in the longitudinal direction X-X, or, as shown in FIG. 4, with a screw 2 which operates with its head 2b on the base of the corresponding seat 100a; in both cases, tightening the screw in the vertical direction Z-Z and clamping the part 10 onto the wire 1a causes deformation of the former (indicated by broken lines) with generation of a twisting moment which, being transmitted to the screw 2, causes jamming thereof, preventing it from being slackened and from moving outwards.

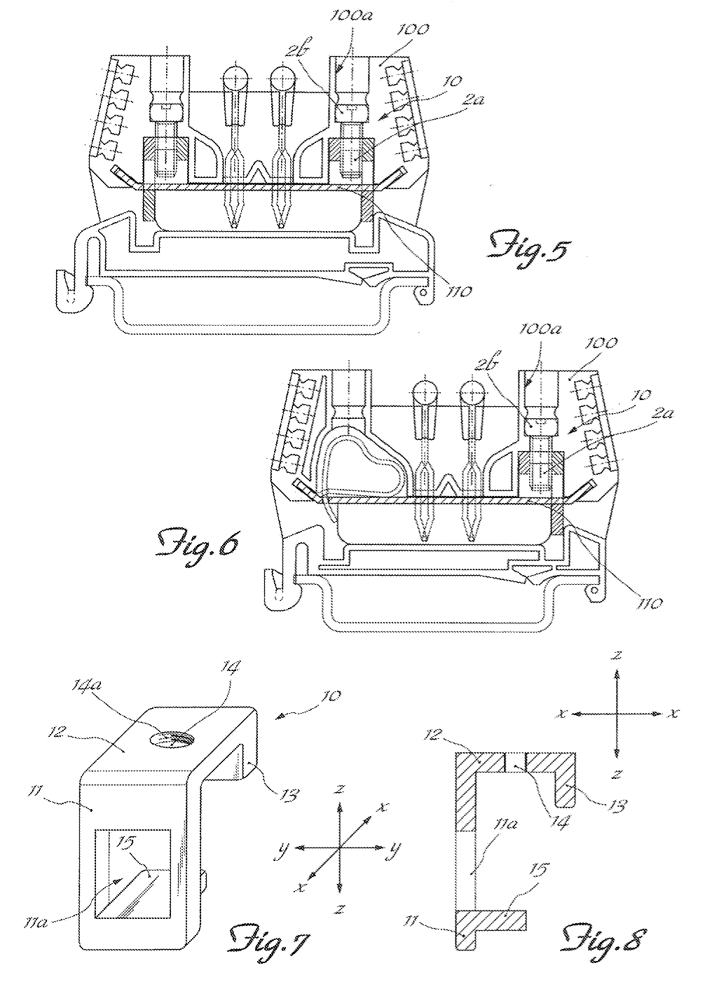

FIGS. 5 and 6 show further modes of application of the clamping part 10 according to the present invention, from which it can be seen that, owing to the smaller dimensions of the clamping part, the latter may be applied as an alternative to a resilient plate, also inside the same terminal block 100; in addition it is pointed out how, unlike the known art, with the clamping part according to the present invention it is possible to design the counter-plate 110 with one form which is always the same in all applications with obvious advantages in terms of simplified production and easier management of warehouse stocks.

Finally, FIGS. 7 and 8 show a second embodiment of the clamping part according to the present invention which is provided by forming the opening of the hole 11a in the vertical face 11 by means of inwards folding of the tongue 15 which is not cut as in the case of FIGS. 1 and 2, but remains integral with the body 10 and assists clamping of the wire 1a.

It is therefore clear how with the clamping part according to the present invention it is possible to achieve much simpler and faster large-scale production, with a simultaneous saving of material used and a reduction in the overall dimensions, while ensuring at the same time ease of operation by means of a screw and secure clamping by means of a resilient plate, also owing to the fact that the clamping action and electric contact are achieved over a smaller section of the vertical face which is perpendicular to the longitudinal direction X-X of the wire 1a, unlike that which occurs in the known art where the contact is obtained over a broad surface area which is not very efficient owing to the smaller specific clamping force.

In addition, it can be seen how the female thread of the clamping part which co-operates with the actuating screw is formed in the thickness of a single face instead of a double face as in the known art, with a consequent reduction in the amount of material, but without weakening the structure.

1. A wire clamp for connecting electric wires comprising a conducting body in the form of an overturned L having a vertical face and a horizontal face.

2. A clamp according to claim 1, wherein the vertical face extends vertical direction having a vertical length and the horizontal face extends in a longitudinal direction having a longitudinal length, wherein the vertical length of the vertical face is greater than the longitudinal length of the horizontal face.

3. A clamp according to claim 1, wherein the vertical face of the conducting body is perpendicular to the longitudinal direction of insertion of the wire.

4. A clamp according to claim 3, wherein the vertical face has an opening adapted for insertion of an end of a wire in the longitudinal direction.

5. A clamp according to claim 1, wherein the conducting body includes a longitudinal horizontal face having a component adapted for engagement with an actuating element.

6. A clamp according to claim 5, wherein the engagement component includes a hole extending along a vertical axis having a female thread.

7. A clamp according to claim 5, wherein the actuating element includes a screw having a threaded shank, the thread corresponding to the female thread of the engagement component.

8. A clamp according to claim 1, wherein the longitudinal horizontal face includes a free end folded downwards in a substantially vertical direction.

9. A clamp according to claim 8, wherein the folded free end interferes with an actuating screw element of the conducting body and causes locking of the screw element with respect to the conducting body when the screw is actuated.

10. A clamp according to claim 2, wherein the longitudinal horizontal face has a single thickness.

11. A clamp according to claim 1, wherein the vertical face of the conducting body is perpendicular to the longitudinal direction of insertion of the wire, and
the vertical face has an opening adapted for insertion of an end of a wire in the longitudinal direction and a tongue extending in the longitudinal direction from the opening for contacting the wire.
